(19) United States
(12) Patent Application Publication
(10) Pub. No.: US 2009/0219865 A1
(43) Pub. Date: Sep. 3, 2009

(54) Information Encoding for a Backward Channel

(75) Inventors: Thomas Salzer, Paris (FR); Marios Kountouris, Bretonneux (FR)

Correspondence Address: MCKENNA LONG & ALDRIDGE LLP, 1900 K STREET, NW, WASHINGTON, DC, 20006, US

(73) Assignee: France Telecom, Paris (FR)

(21) Appl. No.: 12/085,092

(22) PCT Filed: Nov. 16, 2006
(86) PCT No.: PCT/FR2006/002532

§ 371 Date: May 15, 2008

(30) Foreign Application Priority Data
Nov. 17, 2005 (FR) 0511654
Jun. 20, 2006 (FR) 0605481

(51) Int. Cl. H04W 72/08

(52) U.S. Cl. 370/329; 455/452.2

(57) ABSTRACT

The invention relates to an information encoding method for the backward channel of a base station (BS) of a mobile radio system. The base station (BS) comprises M resources and periodically emits (t), toward user terminals (UT), pilot signals enabling, via the latter, the measurement of quality of transmission of resources values (I). The storage (A) of at least one quality of reception of resources value ensues and the transformation (B) of each quality of reception of resources value (II) ensues by quantization into a quantized index value representative of the quality of reception value and constitutive of a metrix relative to each resource. The invention is for use in SDMA and/or OFDMA.

The present invention relates to information encoding for return channels of a mobile radio system.

It can notably concern an MIMO (Multiple-Input, Multiple-Output) transmission system, applying the space-division multiple-access technique or even an OFDMA type system. In the first type of system, beams from different antennas are allocated as resources to the user terminals, whereas these resources are made up of frequency sub-bands in the second, OFDMA-type system.

The space-division multiple-access (SDMA) transmission systems are characterized by the use of multiple antennas in transmission to generate separate beams, each of which can be allocated to a different user terminal.

In the abovementioned SDMA systems, the algorithm for allocating transmission/reception resources, and therefore beams, to the user terminals, requires a knowledge of information concerning the reception quality expected for a large number of users and beams.

The abovementioned systems use a return channel, designated uplink channel, to send information concerning the state of the radio transmission channel to the base station, unlike the transmission channel from the base station to the users, designated downlink channel.

Because of the large number of users and of beams for each base station, for example in mobile telephony, the quantity of information transmitted over the return channel soon becomes prohibitive.

Reducing the abovementioned quantity of information normally entails using a less powerful resource allocation algorithm. Consequently, the prior art techniques of transmitting metrics over SDMA system return channels aim to reduce the necessary quantity of information transmitted over the return channel, while maintaining the use of a resource allocation algorithm which is as powerful as possible.

Thus, one known technique of transmitting information by return channel is that which is the subject of the publication entitled “On the capacity of MIMO broadcast channel with partial side information”, IEEE Transactions on Information Theory, Vol. 51, No. 2, pp. 506-522, M. Sharif, B. Hassibi, February 2005. According to this technique, each user terminal transmits over the return channel only the value of the best signal-to-interference plus noise ratio, designated SINR, and a reference index of the beam for which this ratio has been obtained. The information sent by each user terminal over the return channel therefore comprises a real value, representing the abovementioned ratio value, and an integer between 1 and M, being the index of the beam out of the M beams. The abovementioned technique also suggests a reduction in the overall quantity of information sent over the return channel when only the user terminals for which the SINR value is greater than a threshold value transmit this information over the return channel.

The abovementioned prior art technique uses real values to carry the information transmitted over the return channel, which constitutes a large quantity of information for each user and requires this information to be represented on a real number basis.

The quantization needed for this representation is likely to falsify the comparison of the metrics between user terminals, executed in the allocation algorithm, particularly when the dynamic of the metrics differs very widely from one user terminal to another, which is unfortunately the case in a real SDMA-type telecommunication system.

In the abovementioned prior art technique, the resource allocation algorithm knows only the quality indication for a single beam for each user terminal and, consequently, cannot take into account the effects of interference between beams present in the SDMA-type systems.

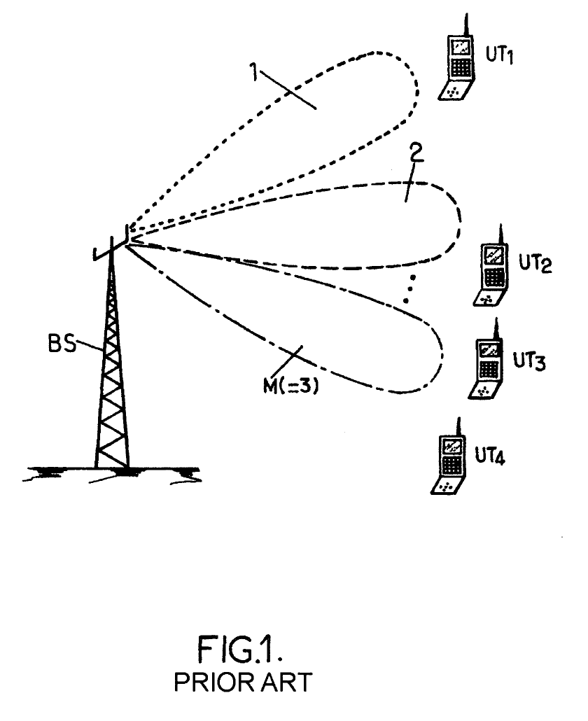

Referring to FIG. 1, the issue of resource allocation in an SDMA-type transmission system is explained hereinbelow.

In an SDMA system, the multiple antennas in transmission are used to generate different beams, which represent the resources which can be allocated to different user terminals.

The number of different beams that can be generated simultaneously is normally identical to the number M of antennas, this number being, in FIG. 1, equal to 3 by way of nonlimiting example, and the maximum number of users who can be served simultaneously is also equal to M.

A group of M antennas can, however, generate an infinite number of sets of M separate beams.

The optimum choice of this set depends on the relative positioning of the user terminals that must be served simultaneously and the state of their radio transmission channels.

To determine the users who can be served simultaneously with a given set of beams, the base station transmits pilot signals on each of the beams. These signals are detected by the user terminals which return a quality indicator for one or more beams over the return channel. Based on these quality indicators, the base station decides on the allocation of the beams to the users.

One important characteristic of the SDMA-type systems is the fact that, since the orthogonality of the beam resources is not assured, there is a not-inconsiderable level of interference between the signals transmitted on the different beams on the user receivers.

To limit this interference phenomenon, the choice of the set of beams and of the set of users served simultaneously is crucial.

As an example, referring to FIG. 1, consider the corresponding situation.

The base station has M=3 antennas and is therefore able to serve three of the four user terminals that are simultaneously present.

If the set of beams created by the antenna array of the base station is compared with the state of the radio transmission channels of the user terminals, represented in FIG. 1 only by their position, the compromise that has to be made can be understood.

Firstly, the base station must choose between the user terminals 3 and 4, which are both covered by the beam 3, but cannot be served simultaneously by the latter.

One possible choice, secondly, would therefore be to serve the user terminal 1 with the beam 1, the user terminal 2 with the beam 2 and the user terminal 3 with the beam 3.

The user terminal 2 is between the beams 2 and 3, which means that it receives said beams with similar quality. Consequently, signals transmitted with the beams 2 and 3 arrive on the user terminal 2 with a similar strength and therefore create strong interference.

The quality of the signal which, in this assumption, would be transmitted on the beam 2 is therefore not assured.

Knowing that a signal transmitted on the beam 2 also creates an interference phenomenon on the user terminals 1 and 3, the use of the beam 2 is not optimal.

The best choice for the system would be, given the abovementioned assumption, to save on the power needed to serve the user terminal 2 and serve only the user terminals 1 and 3, then to serve the user terminals 2 and 4 by means of another set of beams.

Similar problems also arise in an OFDMA context. An orthogonal frequency-division multiple access (OFDMA) mobile radio system uses an OFDM modulation with a multiple access scheme combining:
an FDMA (Frequency Division Multiple Access) frequency multiplexing, and
a TDMA (Time Division Multiple Access) time multiplexing.

Referring to FIG. 1A, in such a system, a base station BS dynamically allocates to each terminal UT1, UT2, UT3, a set of frequency sub-bands for a certain time slot. Thus, referring to FIG. 1B illustrating the allocation of sub-bands, out of the M frequency sub-bands (axis F), in one and the same transmission time slot tᵢ (axis t), a first terminal UT1 is allocated, in the example represented, three sub-bands, whereas a second terminal UT2 is allocated two sub-bands.

The abovementioned information feedback enables the base station BS to know about the quality of the transmission link to the terminals UT1, UT2, UT3. The information feedback is provided by communicating a set of information (or “metrics”) via the return channel VR (FIG. 1A). This set comprises metrics for each sub-band and an overall quality metric. The metrics are generated from measurements performed using a reference signal REF sent by the base station BS. This information is used in particular to optimize:
the scheduling of the users,
the allocation of the resources (in this case, frequency sub-bands), and
the adaptation of the link, i.e. the choice of the optimum modulation and encoding scheme.

These parameters are managed by algorithmic processes hereinafter generically referred to as “radio resource management”.

Normally, efforts are made to reduce the necessary quantity of information on the return channel while enabling rapid and efficient resource management. This search for the optimum is an issue which arises in particular for an OFDMA system, but also in the case of a hybrid system combining an OFDMA technique with other multiple-access techniques (like code division multiple access CDMA or space division multiple access SDMA) involving one or more return metrics for each sub-band. Typically, a hybrid OFDMA/SDMA implementation could entail considering as feedback a matrix of dimension N×M, where N corresponds to the number of beams to be allocated and M corresponds to the number of sub-bands to be allocated.

In all the mobile radio communication systems that use a return channel to send information on the radio link quality, efforts are made to find a compromise between the quality of the information required by this feedback and the quantity of information sent. In an OFDMA system in particular, where the resource allocation process requires information on the reception quality expected for a large number of users and sub-bands, the quantity of information sent over the return channel soon becomes prohibitive. On the other hand, reducing this quantity normally entails using a less efficient resource management. One aim to be achieved is therefore, once again, to reduce the quantity of information concerning the quality of the link, this quantity being necessary on the return channel, while enabling a rapid and efficient radio resource management.

Resource management in an OFDMA system normally uses the feedback of a link quality indicator for each active terminal. This principle is already used in particular in the HSDPA-type systems.

Notably, in such an HSDPA (High Speed Downlink Package Access) system according to the 3GPP standard TR 25.212 V6.6.0, “Multiplexing and channel coding (FDD) (Release 6)”, to obtain an indicator of the link quality for each active user, the base station sends pilot signals which enable the terminal to measure the signal-to-interference plus noise ratio (SINR). This measurement constitutes a real value which would require a large quantity of information if it were used directly as an information feedback metric. The terminal in fact uses the SINR measurement simply to determine a quality indicator CQI (Channel Quality Indicator) which corresponds to the best modulation and encoding scheme that can be used in transmission with the SINR measurement made. The CQI indicator sent over the return channel here corresponds to an integer value identifying the optimum modulation and encoding scheme to be applied, out of several possible schemes.

This integer can advantageously be encoded on a few bits, for example on five bits (between 1 and 32). Nevertheless, the problem of saving on feedback information transmitted does not truly arise for an HSDPA system since in this case only a single resource has to be managed, whereas an OFDMA system has to manage the allocation of several resources and additional information transmitted by the return channel is necessary for this purpose.

This technique is moreover not directly applicable to an OFMDA system, for at least two reasons.

Since several sub-bands can be allocated to a user, the variation of the quality of the link frequency-wise (from one sub-band to another) must be taken into account to determine the best applicable modulation and encoding scheme.

Moreover, the sub-bands in an OFDMA context can be dynamically allocated to different users, and a terminal cannot determine in advance the best modulation and encoding scheme without knowing the sub-bands that will be allocated to it. In this case, the average measurements (performed over all of the sub-bands) can prove inappropriate.

A single quality indicator is normally not sufficient for the broadband OFDMA systems because the quality of the link varies strongly with frequency. The powerful resource management algorithms require information feedback on the SINR measurements performed by each terminal on each sub-band (or M real values as illustrated in FIG. 1B), which represents a very large quantity of information. Several techniques for reducing this quantity have been proposed, notably that explained in the 3GPP standardization contribution, R1-051334, “CQI Feedback Scheme for EUTRA” (Motorola, RAN1#43, Seoul (South Korea), November 2005). It consists in sending only one average real value of SINR measurements on the return channel. This average value is calculated over a limited number of sub-bands. The sub-bands targeted by this average value are indicated to the base station by the transmission of a series of zeros and ones (or “bitmap”) of size log₂(M) indicating the use or non-use of a sub-band in calculating the average value.

Nevertheless, this “bitmap” series does not give information on the relative quality of one sub-band compared to another, whereas this information is important for managing the allocation of resources and for scheduling users.

Furthermore, this “bitmap” series does not make it possible to favor one user over another for the allocation of a sub-band. The only measurement that can be used to schedule users in accordance with this technique is the average SINR value.

The object of the present invention is to overcome the abovementioned drawbacks in the state-of-the-art solutions.

In particular, one objective of the present invention is to implement an information encoding method for the return channel of a mobile radio system, by establishing a specific metric which is not very complicated, which enables the base station to perform an optimized resource management for one or more given sets of resources.

It will be understood that the term “mobile radio system” is used to mean both an MIMO transmission system (SDMA) in which the abovementioned beams constitute the resources, and an OFDMA system in which the frequency sub-bands then constitute the resources to be allocated.

Another objective of the present invention is, in particular, to establish a metric which, although requiring only an extremely small quantity of information to be transmitted over the return channel, makes it possible to retain excellent properties for the allocation of resources by the base station.

Another objective of the present invention is, by establishing the abovementioned metric, to implement an adaptive standardization of the metrics established for each user terminal and transmitted over the return channel, even if the average and/or the variance of the reception quality varies strongly between the various user terminals, which makes it possible to implement a fair resource allocation process, by the base station, between user terminals.

A subject of the present invention is thus an information encoding method for the return channel of a mobile radio system, in which each base station has at least one set of M resources and periodically transmits to the user terminals pilot signals enabling these user terminals to measure a reception quality value associated with said resources. The method according to the invention includes, at least, the storage of at least two reception quality values associated with said resources and the conversion of each reception quality value associated with said resources, by quantization, into a quantized index value, representative of this reception quality value and constituting a metric relating to each resource.

The method that is the subject of the invention is also noteworthy in that, for a periodic transmission of predetermined period t, with pilot signals generating a plurality of successive measurements according to the same period, of reception quality values for each resource available on each user terminal, this method also includes the storage, over a predetermined number T of periods prior to the current period, of reception quality values, and the creation of a rolling observation window by updating the T reception quality values, based on the reception quality values of the current period.

The method that is the subject of the invention is also noteworthy in that the set of all the reception quality values relating to the M resources over the T updated periods is subjected to a sorting process on each user terminal, so as to establish a succession of decreasing reception quality values, the index of each value being representative of the relative reception quality of each resource with respect to the other resources and with respect to the successive trend of this reception quality in the T stored periods.

The method that is the subject of the invention is finally noteworthy in that the index of each quality value in the abovementioned succession is quantized in relation to a predetermined number N of quantization levels, to generate said metrics, which can be transmitted over the return channel, each comprising an integer number between 1 and N.

Another subject of the invention is a user terminal of a mobile radio system transmitting via at least one base station periodically transmitting pilot signals enabling this user terminal to measure a reception quality value associated with resources assigned by this base station. According to the invention, this user terminal is noteworthy in that, besides a central processing unit, a working memory and a module for measuring the reception quality from the pilot signals, it comprises at least one module for storing at least two reception quality values associated with said resources, and a module for converting each reception quality value associated with the resources, by quantization, into a quantized index value, representative of the reception quality value and constituting a metric relating to each resource.

Another subject of the present invention is a base station of a mobile radio system, this base station comprising means of allocating resources to user terminals, and means of periodically transmitting pilot signals enabling any user terminal to measure a reception quality value associated with the resources. According to the invention, this base station is noteworthy in that it comprises at least one module for receiving quantized index values transmitted over the return channel by the user terminals, these quantized index values being representative of at least one reception quality value associated with the resources, and constituting metrics of these resources; and means of controlling the allocation of the resources to each user terminal according to the quantized index values.

The base station which is the subject of the invention is also noteworthy in that the means of controlling the allocation of the resources also includes a unit for comparing at least one quantized index value representative of the reception quality of a user terminal with the quantized index values representative of the reception quality established for each of the other user terminals.

In an SDMA context, the means of controlling the allocation of the resources of the base station can advantageously also include a unit for comparing at least one quantized index value, representative of the reception quality of a user terminal, with a reference value, which is quantized relative to one and the same number N of quantization levels as that used to generate the metrics of the resources. Thus, for an SDMA system, this makes it possible to make the allocation and/or the generation of a set of resources (as beams) conditional on the reference value.

The invention will be better understood from reading the description and studying the drawings below, in which, besides FIGS. 1, 1A and 1B described hereinabove:

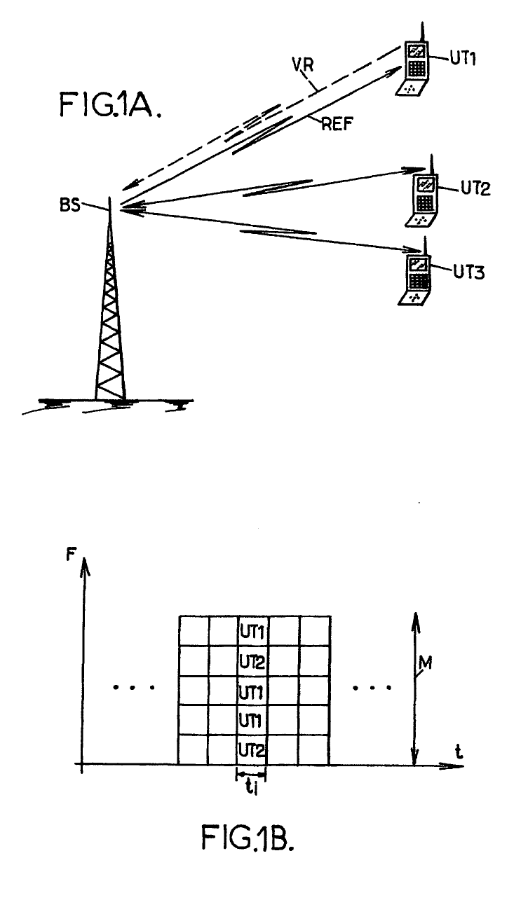

FIG. 2a represents, by way of illustration, a flow diagram of the steps of the information encoding method for the return channel of a mobile radio system according to the invention;

FIG. 2b represents, by way of illustration, a flow diagram of a nonlimiting embodiment of the storage step of the method illustrated in FIG. 2a;

FIG. 2c represents, by way of illustration, a flow diagram of a nonlimiting embodiment of the quantization step proper of the method illustrated in FIG. 2a;

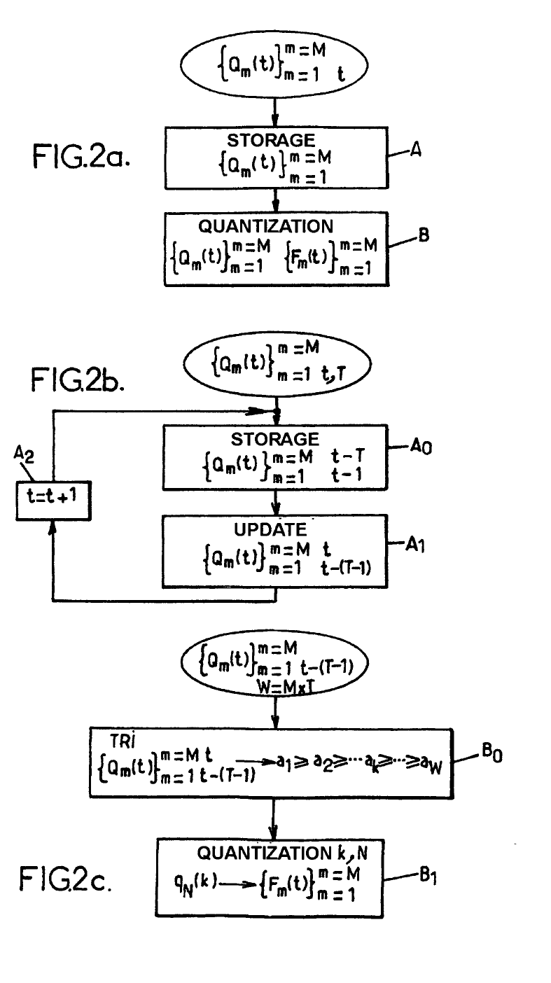

FIG. 3 represents, by way of illustration, a mapping of sequences arranged in descending order of reception quality values on a predetermined number N of quantization levels;

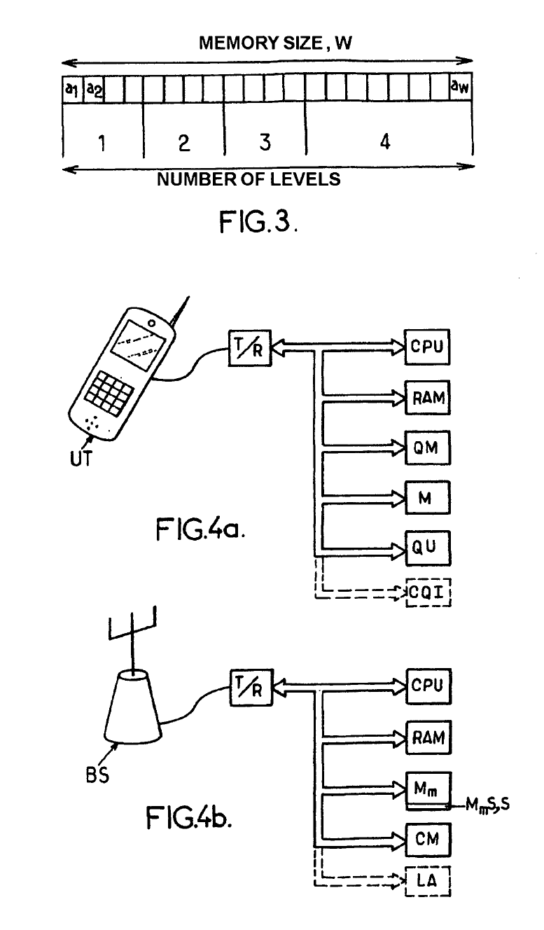

FIG. 4a represents, by way of illustration, the internal architecture of a user terminal that is the subject of the invention, specially configured to implement the method that is the subject of the invention;

FIG. 4b represents, by way of illustration, the internal architecture specific to the adaptation of a base station specially configured for a use of the resource and user terminal metrics, as illustrated in FIG. 4a, either for resource management or for reconfiguration by modifying the orientation of the existing beams, notably in an SDMA-type transmission context;

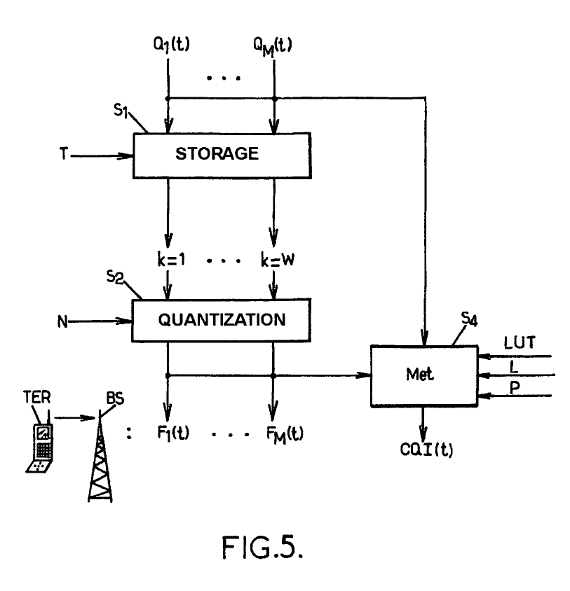

FIG. 5 is a schematic functional diagram of one embodiment of the invention in an OFDMA context;

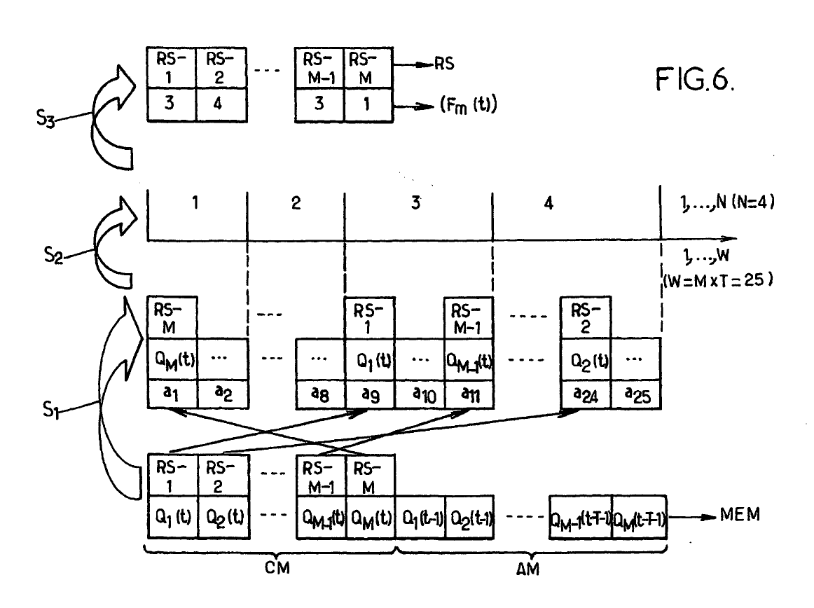

FIG. 6 illustrates an example of the indexing process on the measurements relating to the resources (beams or sub-bands) and of the index quantization process in an embodiment in an SDMA context or even an OFDMA context,

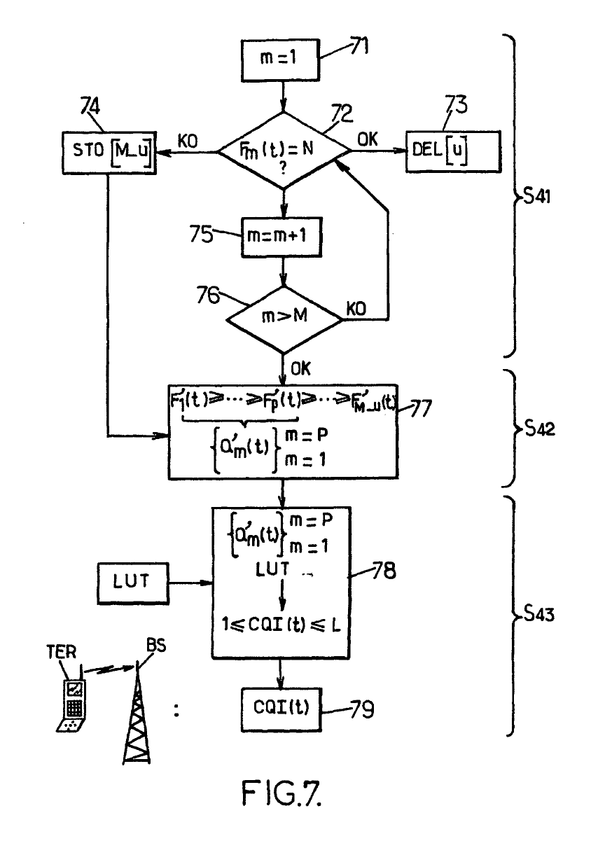

FIG. 7 details an exemplary implementation for calculating the indicator CQI(t) in an OFDMA context.

A more detailed description of the information encoding method for the return channel of a mobile radio system which is the subject of the invention will now be given hereinafter in conjunction with FIGS. 2a to 2c and the subsequent figures.

As a general rule, it will be recalled that each base station BS of the abovementioned system has at least one set of a plurality M of resources, as represented in FIG. 1 and FIG. 1B for both SDMA and OFDMA cases respectively, and periodically transmits in each resource pilot signals enabling the user terminals UT1 to UT4 to measure a reception quality value associated with the resources.

As indicated previously, these resources comprise beams from separate antennas in an SDMA-type system, and frequency sub-bands in an OFDMA-type system.

Thus, on each user terminal UT, there are successive reception quality values associated with the resources, these values being denoted:

{Qₘ(t)}ₘ₌₁^{m=M},

these values, according to the prior art, being delivered successively and retransmitted on the return channel.

However, and according to one noteworthy aspect of the method that is the subject of the present invention, as represented in FIG. 2a, the latter comprises at least the steps A for storing at least two reception quality values associated with the resources, namely values {Qₘ(t)}ₘ₌₁^{m=M}. The storage step A is then followed by step B for converting each reception quality value associated with the resources, by quantization, into a quantized index value representative of the reception quality value and constituting a metric relating to each resource.

In FIG. 2a, in the step B, the quantization conversion operation is denoted:

$${\{ {Q}_{m} ( t ) \}}_{m = 1}^{m = M} \to {\{ {F}_{m} ( t ) \}}_{m = 1}^{m = M} .$$

In the above relation, it should be indicated that Fₘ(t) designates a metric associated with the resource of rank m and that the metric concept designates any indicator making it possible to measure the transmission performance.

It will be understood, in particular, that because of the transmission of each reception quality value associated with the resource in the form of a quantized index value, which, as will be described later in the description, can be represented by an integer number, the quantity of information transmitted to the base station BS is then substantially reduced.

As a general rule, it should be indicated that the values Qₘ(t) can comprise measurements of signal-to-interference plus noise ratio values, the ratio being designated SINR, the strength of the pilot signal transmitted and received by each user terminal UT or any other appropriate measurement.

As a general rule, as represented in FIG. 2b, the method that is the subject of the present invention advantageously consists in performing a periodic transmission of predetermined period t of the pilot signals, so as to generate a plurality of successive measurements of reception quality values of the same period for each resource available on each user terminal UT.

Given these conditions, the method that is the subject of the invention then makes it possible, particularly advantageously, to take into account a plurality of T reception quality measurement values from preceding slots Q₁(t−1), . . . , Q_{M}(t−1), . . . , Q₁(t−T), . . . , Q_{M}(t−T).

As represented in FIG. 2b, in the nonlimiting preferred embodiment of the method that is the subject of the invention, the step A of FIG. 2a can then, in a step A₀, consist in having the reception quality values stored over a predetermined number T of periods prior to the current period, this operation being denoted:

$$Storage {\{ {Q}_{m} ( t ) \}}_{m = 1 t - 1}^{m = M t - T} .$$

The step A₀ can then be followed by a step A₁, consisting in creating a rolling observation window by updating the T reception quality values, based on the reception quality values of the current period. It will thus be understood that on each period t of transmission of the pilot signals, and ultimately of creation of the reception quality measurement values on each terminal UT, the set of the T reception quality values is then updated by eliminating the measurements of the earliest preceding period t−T and by adding reception quality value measurements of the current period of the period t.

This operation, in the step A₁, is denoted:

$$Update {\{ {Q}_{m} ( t ) \}}_{m = 1 t - ( T - 1 )}^{m = M t} .$$

In FIG. 2b, the updating concept is represented by the step A₂, which, from the step A₁, consists in replacing t with the value t+1 to go on to the next current period and return to the storage step A₀ to perform the abovementioned updating.

A more detailed description of the quantization step B, represented in FIG. 2a, will now be given in conjunction with FIG. 2c.

To validly handle the quantization operation on the reception quality measurement values, this number of measurements being equal to W=M×T, the inventive method consists, in a step B₀, in performing a sorting process on the set of all the reception quality values relating to the M resources over the periods T updated by reception quality values of each of the user terminals.

The abovementioned sorting process thus makes it possible to establish a succession of decreasing reception quality values, this sorting operation being denoted in the step B₀ of FIG. 2c:

$$Sort {\{ {Q}_{m} ( t ) \}}_{m = 1 t - ( T - 1 )}^{m = M t} \to {α}_{1} \geq {α}_{2} \geq … \geq {α}_{k} \geq … \geq {α}_{w} .$$

In the above relation, it will be understood that the sort relates to the set of the reception quality values relating to the M resources in the T successive periods stored and that the decreasing reception quality value sequence is denoted:

α₁≧α₂≧ . . . ≧αₖ≧ . . . ≧α_{w}.

Thanks to the abovementioned sorting process, the index of each sequence, index k, is thus representative of the value of the reception quality relating to each of the resources with respect to the other resources, and with respect to the successive trend of this reception quality in the T stored periods. In other words, each measurement Q₁(t), . . . , Q_{M}(t) is then represented by its index k in the sorted sequence. This index k is an integer between 1 and W=M×T.

The step B₀ is then followed by a step B₁ consisting in performing a step for quantizing the index k of each sequence relative to a predetermined number N of quantization levels.

The quantization operation proper, in the step B₁ of FIG. 2c, is denoted:

$${q}_{n} ( k ) \to {\{ {F}_{m} ( t ) \}}_{m = 1}^{m = M} .$$

It will be understood that, in the above-mentioned quantization operation of the step B₁, Fₘ(t) designates the metrics that can be transmitted over the return channel, which then each comprise an integer number between 1 and N.

The method that is the subject of the invention thus makes it possible to replace any measurement value represented by a real number, in particular any reception quality value measurement, with an integer number for which the quantity of information to be transmitted is substantially smaller, which makes it possible to reduce the volume of information transmitted over the return channel.

Thus, each reception quality measurement value is represented by its index k in the sequence aₖ, the index then being quantized relative to the predefined N levels.

Specifically, it should be indicated that the quantization levels can advantageously be nonlinear. In other words, the N levels constitute sets (in principle separate) of which the cardinals are not necessarily equal. As represented in FIG. 3, given this assumption, the N quantization levels are not equidistant. An exemplary construction of the levels consists in choosing each level by grouping together indices between a chosen minimum threshold and a chosen maximum threshold.

It is in particular possible to choose a maximum level that combines all the indices from a certain threshold. The number of quantization levels N and the positioning of these levels can advantageously be configurable and parameterable.

As a general rule, the method that is the subject of the invention makes it possible, for each user terminal UT, to transmit a metric for each resource over the return channel. Given this assumption, the indication of a resource identification index is not necessary.

Nevertheless, according to a nonlimiting embodiment variant of the method that is the subject of the invention, which can be applied to an SDMA system but also an OFDMA system, each resource (beam or sub-band) of a set of resources is assigned an identifier. This makes it possible to implement the method that is the subject of the invention on all or some of the set of resources of each base station. Given this assumption, a resource discrimination can be applied, not to the resources themselves but, on the contrary, to the reception quality measurement values, which then makes it possible, in the step for sorting these measurement values, as represented in the step B₀ of FIG. 2c, to apply a resource discrimination according to specific criteria, when allocating the latter.

Of course, the method that is the subject of the present invention can be used for the allocation of a set of resources of a base station of an SDMA system or of an OFDMA system. In both cases, the metric values, transmitted in the form of integer numbers, are used to perform the allocation of the resources to the user terminals UT. The allocation is thus performed by comparing the quantized index value representative of the reception quality of a user terminal with the quantized index values representative of the reception quality established for each of the other user terminals.

Thus, the method that is the subject of the invention can be used thanks to the transmission of the abovementioned metrics in the form of integer numbers transmitted over the return channel.

By way of nonlimiting example, it should be indicated that the allocation process can, for example, consist in allocating a resource to the user terminal that has, compared to the other user terminals, the lowest metric for the resource concerned, in order to favor this user terminal that has a relatively good reception quality.

It is important to note the excellent character of the properties of the metrics sent over the return channel for resource allocation.

In a real system, the reception quality of a set of user terminals UT is distributed very non-uniformly between user terminals according to their position in relation to the base station BS.

The proposed metric, according to the encoding method that is the subject of the invention, applies a quantization which is adapted automatically to each user and detects the favorable transmission resources and instants for the user terminal concerned.

Consequently, the method that is the subject of the invention makes it possible to perform a fair allocation of resources between users.

Because of the fact that the quantity of information required by each metric transmitted over the return channel is very small, the method that is the subject of the present invention makes it possible to send a metric for each of the resources over the return channel.

Notably in an SDMA system, the transmitted information can then be used by resource allocation processes to take account of the interference between the beams. The allocation principle can consist in detecting users who obtain, for certain beams, a strong interference level, that is, who obtain a good reception quality for several beams simultaneously.

Another advantage for the SMDA application is that the generation of a set of beams from a base station and, in particular, the orientation of these beams in the transmission direction can be made conditional on a reference value, which can be quantized in relation to one and the same number N of quantization levels as that used to generate the metrics transmitted over the return channel.

Reference is now made to FIG. 6 to describe a detailed example illustrating the sequencing of the general steps of FIGS. 2a, 2b and 2c.

There are M measurements associated with M resources (referenced CM and denoted Q₁(t), Q₂(t), . . . , Q_{M-1}(t), Q_{M}(t)) performed at a current instant t. There are also Mx(T−1) preceding measurements (referenced AM) performed at instants t−1, . . . , t−T−1, preceding the current instant t. The set of these measurements CM and AM is stored in a memory MEM, for example of overall size W=M×T and which can, for example, be a FIFO (First-In, First-Out) type memory to be progressively refreshed and so eliminate the measurements at the instant t−T when those performed at the current instant t are available. This implementation conforms to the content of FIG. 2b described previously.

It will be noted that the measurements at the current instant t, at least, are each stored in the memory MEM mapped to a respective resource identifier (denoted RS-1, RS-2, . . . , RS-M−1, RS-M). It will be remembered that these resources RS-1, RS-2, . . . , RS-M−1, RS-M can be beams in an SDMA context or sub-bands in an OFDMA context.

The step S1 of FIG. 6 aims to sort the W measurements, in total, according to their value and index them on W indices. In the example represented:
the measurement performed at the current instant t in relation to the last resource RS-M is indexed 1 and therefore corresponds to the highest value found,
the measurement performed at the current instant t in relation to the first resource RS-1 is of index 9 and therefore corresponds to the ninth largest value found,
the measurement performed at the current instant t in relation to the resource RS-M−1 is of index 11 and therefore corresponds to the eleventh highest value found,
the measurement performed at the current instant t in relation to the second resource RS-2 is of index 24 and therefore corresponds to the penultimate value found since the sort is performed in descending order over W=25 values in the example illustrated.

FIG. 3 represents the state of the memory MEM after the step S1. In practice, the storage in memory of the W sorted values conforms to the illustration of FIG. 3 described previously.

The next step S2 aims to distribute these W indices over N levels only (with N less than or equal to W and set at N=4 in the example illustrated), in accordance with the content of FIG. 2c described previously. Thus, in the example represented:
the measurement performed at the current instant t in relation to the last resource RS-M (of index 1) is assigned to the first level “1”,
following the broken lines which extend from the levels “1”, “2”, “3”, and “4” downward, the measurement performed at the current instant t in relation to the first resource RS-1 (of index 9) is assigned to the third level “3”,
the measurement performed at the current instant t in relation to the resource RS-M−1 (of index 11) is assigned to the third level “3”,
and the measurement performed at the current instant t in relation to the second resource RS-2 (of index 24) is assigned to the fourth level “4”.

It is these level values which are ultimately assigned to the resource identifiers RS-1, RS-2, . . . , RS-M in the step S3.

Thus, F₁(t)=3, F₂(t)=4, . . . , F_{M=1}(t)=3 and F_{M}(t)=1 represent the values, sorted, indexed and quantized on N=4 levels, of the M measurements performed in relation to M resources at one and the same current instant t.

There now follows a description of a specific exemplary embodiment but one that is not limited to the application of the invention to OFDMA systems.

As described hereinabove with reference to FIG. 1B, an OFDMA system has M sub-bands in the frequency domain. The base station BS periodically sends pilot signals REF which enable the terminals to measure the link quality in each sub-band. This measurement can be the signal-to-interference plus noise ratio (SINR) or any other appropriate quality measurement.

A terminal therefore has, in each transmission slot t, M quality measurements hereinafter denoted Q₁(t), . . . , Q_{M}(t). From these measurements, it is possible to determine:
M integer feedback metrics, the values of which are between 1 and N. These M metrics represent the relative quality of each sub-band, since they represent, in an SDMA context, the relative quality of each beam,
an integer metric between 1 and L indicating the preferred modulation and encoding scheme which, by way of example, can be of the same form as the metric used in the HSDPA systems described hereinabove.

The determination of the M metrics F₁(t), . . . , F_{M}(t) for an OFDMA system, by classifying measurements, indexing and quantizing on N levels, is identical to that described hereinabove for an SDMA system, with reference to FIGS. 2a, 2b, 2c and 3.

For the determination of the CQI indicator (Channel Quality Indicator), reference is then made to FIGS. 5 and 7, in which:
M is the number of resources (frequency sub-bands in OFDMA mode),
W represents the number of measurements taken into account in the observation period T,
the channel quality measurements for each sub-band in a rolling time window are real scalars denoted Qₘ(t−k) (m=1, . . . , M; k=1, . . . , T) and consist of input parameters,
LUT (Look-Up Table) denotes a mapping table for evaluating the CQI indicator of the optimum modulation and encoding scheme, and so constitutes an input parameter,
the level of a current measurement for each resource is a natural integer between 1 and N, denoted Fₘ(t) (m=1, . . . , M), and consists of an output parameter,
the level for the adaptation of the link is a natural integer between 1 and L, denoted CQI (t) and also consists of an output parameter,
the length of the rolling observation window, in terms of quantity of transmission slots, is a natural non-zero integer, denoted T and consists of a configurable parameter,
the number of levels denoted N is a natural integer between 1 (in which case a single level comprises all the measurements) and W=M×T (in which case each level comprises only a single measurement), and also consists of a configurable parameter,
the number of levels for the link adaptation, denoted L (integer), is also a configurable parameter, and
the number of sub-bands used in calculating the indicator CQI(t), denoted P (integer), is also a configurable parameter.

Referring to FIG. 5, once the measurements Q₁(t), . . . , Q_{M}(t) have been performed on the M resources (in this case, sub-bands) at one and the same current instant t, the steps S1 (refreshing the memory content) and S2 (sorting the measurements in descending order, indexing on W indices, then quantizing on N levels) are carried out to deliver M quantized values F₁(t), . . . , F_{M}(t). These steps S1 and S2 remain compliant with those described previously with reference to FIG. 6 in a general SDMA or OFDMA context.

The M metric values F₁(t), . . . , F_{M}(t) are already transmitted from the terminals TER to the base station BS. However, in an OFDMA context, each terminal also transmits an indicator CQI(t) calculated for the current instant t, in a step S4. Thus, to ensure the adaptation of the link on transmission, each terminal also determines a metric corresponding to a preferred modulation and encoding scheme. This metric CQI(t) comprises an integer value between 1 and L.

The calculation of the indicator CQI(t) is preferably performed as follows. At the moment when this indicator must be calculated, the terminal generally knows the number P of sub-bands (FIG. 5) which can be allocated to it, but does not know their position in the total transmission band. Obviously, this number P remains less than the total number M of sub-bands. Since the quality of the channel varies strongly from one sub-band to another, the calculation of this indicator must take into account at one and the same time:
the number P of sub-bands,
the measurements Q₁(t), . . . , Q_{M}(t), and
the metrics F₁(t), . . . , F_{M}(t) sent to the base station over the return channel.

One possible implementation of this calculation can be performed in the following steps:
the sub-bands for which the quantized index Fₘ(t) is maximum (that is, equal to N) are disregarded, assuming that these sub-bands will not be allocated by the base station,
a set of measurements {Q′₁(t), . . . , Q′_{P}(t)} is then formed from the remaining measurements Qₘ(t), on the P sub-bands that have obtained the highest quantized indices Fₘ(t), representative of the remaining sub-bands that have the worst transmission quality (“worst case”),
these measurements {Q′₁(t), . . . , Q′_{P}(t)} are used to determine the maximum modulation and encoding scheme applicable for the transmission, assuming an allocation representative of the “worst case”. The actual determination of the indicator CQI(t) from these P measurements is therefore performed here.

The assumption of an allocation representative of the “worst case” is used to ensure a reliable transmission regardless of how the resources are allocated by the base station.

To determine the indicator CQI(t) (modulation and encoding scheme) from the measurements {Q′₁(t), . . . , Q′_{P}(t)}, mapping tables LUT are used. These tables are generated empirically, for example according to the modulation and encoding schemes normally available.

Referring to FIG. 7, the first step S41 aims to disregard the sub-bands that have too low a quality (of which the value Fₘ(t) is N in the example described), so as not to falsify the estimation of the indicator CQI(t) with reception qualities that are too poor. This first step S41 in estimating the indicator CQI(t) can be described as follows: the value of the index m=1 is set in the initialization step 71 and the corresponding value Fₘ(t) is tested in the step 72. If the value Fₘ(t) is too great (particularly if it has the value of the maximum index N), the sub-band m is disregarded in the step 73 (OK arrow output from the test 72). On the other hand, if the value Fₘ(t) does not satisfy the condition of the test 72 (KO arrow), the corresponding sub-band is taken into account for the rest of the processing operation (step 74). These steps are repeated until the index m=M is used up (incrementing 75 and testing 76 on the value m). In the example represented, a total of U sub-bands have been disregarded (step 73). It will be understood that the values F₁(t), . . . , F_{M}(t) are already used to calculate the indicator CQI(t) when they are compared to a level value (N in the example described).

The next step S42 aims to select, from the M-U remaining sub-bands, those for which the measurements Q′ₘ(t) are the smallest, which is equivalent to the greatest metrics F′ₘ(t), to represent a worst case in calculating the indicator CQI(t). In particular, for each terminal, P greater metrics F′₁(t), . . . , F′_{P}(t) are selected (step 77), this number P corresponding to the number of sub-bands to be used to calculate the CQI.

Finally, the step S43 aims to tangibly calculate the indicator CQI(t), advantageously corresponding to an integer between 1 and L, based on the P measurements Q′ₘ(t) and on the mapping tables LUT (step 78). In practice, a computer routine reads the various measurement values Q′ₘ(t) and compares these measurements with prestored values mapped to a natural integer index in a mapping table LUT. The routine identifies the prestored values which are closest to the remaining measurements Q′ₘ(t) and reads the corresponding index in the LUT table. This index is simply the indicator CQI(t) thus determined for a current instant t. Finally, in the next step 79, the value of the indicator CQI(t) can be transmitted from the terminal TER having performed the quality measurements to the base station BS.

Advantageously, the calculation function and the mapping tables are common to all the user terminals and also known by the base station. The base station can then adjust the choice of the modulation and encoding scheme indicated by the terminal according to the sub-bands that are actually allocated to it.

It will be understood that FIG. 7 can illustrate the flow diagram of a computer program, installed in the memory of a terminal, to execute the calculation of the indicator CQI(t).

Thus, in an OFDMA system in which the present invention is applied, the information sent over the return channel enables a base station to perform in particular the resource management processes mentioned below.
The algorithmic sequencing process determines, for a future transmission slot tᵢ, the terminals which will have sub-bands allocated (the terminals UT1 and UT2 in FIG. 1B). This decision is based, among other things, on the link quality of a terminal compared to the link qualities of the other terminals. To this end, it is therefore advantageous to have an information feedback metric which contains at least one indication concerning the relative link qualities of the terminals in each sub-band.
The algorithmic resource allocation process is adaptive in frequency and determines the number and the positions of the sub-bands allocated to a terminal (three sub-bands for the terminal UT1 and two sub-bands for the terminal UT2 in the example of FIG. 1B). Since this allocation is not fixed from one transmission slot to another, the process advantageously takes account of the relative quality of these sub-bands for all the chosen terminals in the transmission slot concerned tᵢ.
The link adaptation determines the best modulation and encoding scheme for transmission according to the link quality over all the sub-bands that are allocated to it for the time slot concerned tᵢ. This adaptation can therefore be based on the indicator CQI(t) precalculated by the terminal.

We then come back to an integer metric concerning the quality of transmission (value of the indicator CQI which corresponds to the optimum modulation and encoding scheme, and integer metrics concerning the respective relative qualities of the sub-bands). Thus, the invention, by proposing an information feedback metric based on a simple transmission of indices, meets the needs mentioned hereinabove while limiting the quantity of information sent over the return channel. This parameterizable quantity can then be adapted to the requirements of the transmission system.

The advantages provided by this implementation of the present invention are numerous in an OFDMA context.

The set of metrics contains information concerning the relative quality of the various sub-bands, and also information on the overall quality, through the indicator of the preferred modulation and encoding scheme.

The calculation of the indicator of the preferred modulation and encoding scheme is not only dependent on the measurements of the terminal performed on the sub-bands but also takes account of the relative quality metrics of the sub-bands sent to the base station.

The quantity of feedback information for each terminal is considerably reduced because of the use of indices, which are natural integer values.

The metrics on the relative quality of the sub-bands for a user terminal provide for a frequency-adaptive resource allocation.

The metrics used contain information on the relative quality of the sub-bands of one user terminal compared to the sub-bands of another user terminal. The fact that the same calculation of the metric is used by all the terminals allows a fair comparison between user terminals.

The metrics in accordance with the invention provide not only for an allocation of the resource units in the frequency domain but also for an improved sequencing of the user terminals in the time domain, thanks to a rolling window used for calculating the metrics.

There now follows a description of the entities likely to be involved in the implementation of the invention, in an OFDMA or SDMA context, such as a user terminal and/or a base station.

A more detailed description of a user terminal UT of a mobile radio transmission system for transmitting via at least one base station BS will now be given in conjunction with FIG. 4a.

As a general rule, each terminal UT conventionally comprises a transceiver module denoted T/R in FIG. 4a, this module obviously enabling the transmission by microwave channel, and reception by the same channel, of information respectively originating from/addressed to the base station BS. Such is the case in particular when the user terminal UT is a radio communication terminal, for example.

Furthermore, the user terminal UT comprises a central processing unit CPU, a working memory RAM and, of course, conventionally, a module for measuring the reception quality from the pilot signals denoted QM. The abovementioned module for measuring reception quality QM will not be described in detail, because it corresponds to a module known from the prior art, which can be used simply to deliver the reception quality measurement values Qₘ(t) mentioned previously in the description.

Furthermore, as represented in FIG. 4a, the user terminal UT comprises a module M for storing at least two resource reception quality values, namely a value Qₘ(t), described previously.

It finally comprises, as represented in FIG. 4a, a module QU for converting each abovementioned reception quality value, by quantization, into a quantized index value representative of the reception quality value and constituting a metric relating to each resource.

The module M for storing metrics is a storage module of memory size W, as described in FIG. 3, to handle the storage of T successive measurements, in order to enable the rolling window to be updated and created, as described previously in the description.

After the sorting process followed by quantization proper have been carried out, as represented in FIG. 2c, the corresponding quantized values, that is, the metric values Fₘ(t), can be stored at least temporarily in the memory M to then perform the transmission of the corresponding values via the transceiver module T/R over the return channel to the base station BS.

Finally, the module QU for converting by quantization makes it possible to execute the quantization operation, as described in conjunction with FIG. 2c, via the central processing unit CPU and the random access memory RAM. The conversion module QU can advantageously comprise a computer program module, which is called into working memory RAM to be run by the central processing unit.

Furthermore, in an embodiment in an OFDMA context in particular, the terminal of FIG. 4a advantageously comprises a module CQI (represented in broken lines) for determining the quality indicator CQI(t) as described hereinabove with reference to FIGS. 5 and 7.

A more detailed description of a base station of a mobile radio system will now be given in conjunction with FIG. 4b, this system having been specially adapted for the use of the method that is the subject of the present invention and, of course, of the metrics consisting of integer numbers, obtained by implementing the inventive encoding method.

In addition to the conventional installations of a base station, such as transceiver installations T/R and in particular installations transmitting on the downlink channel via a set or several sets of resources (beams or sub-bands), the abovementioned base station that is the subject of the invention advantageously comprises a module for receiving and storing quantized index values transmitted over the return channel, these quantized index values being representative of at least one reception quality value of the resources and constituting metrics of these resources. The module for receiving and storing the abovementioned quantized index values is denoted Mₘ in FIG. 4b.

The base station also comprises a control module for allocating resources to each user terminal, this module being denoted CMA in FIG. 4b. The allocation control module CMA then carries out the allocation according to the quantized index values received and stored in the storage module Mₘ.

Advantageously, the resource allocation control module CMA can also comprise a module for comparing at least one quantized index value representative of the reception quality of a user with the quantized index values representative of the reception quality established for each of the other users.

The control module also includes a unit for comparing at least one quantized index value representative of the reception quality of a user with a reference value denoted S, this reference value being quantized in relation to one and the same number N of quantization levels as that used to generate the resource metrics. This procedure, particularly advantageous for the base station of an SDMA system, makes it possible to make the allocation and/or the generation of a set of beams conditional on the reference threshold value S, as described previously in the description.

The comparison units can be grouped together in a common comparison unit.

As illustrated by way of example in an SDMA context in FIG. 4b, the reference threshold value S can advantageously be stored in the storage unit Mₘ, at a specific reserved address MₘS. The storage unit Mₘ can then comprise a non-volatile programmable memory, which makes it possible, on the one hand, to update the metrics transmitted in each period of transmission of the pilot signals, period t, and, on the other hand, to update the threshold value S solely on the initiative of the operator of the transmission system for the network technical management requirements.

Furthermore in an embodiment in an OFDMA context in particular, the base station of FIG. 4b advantageously comprises a link adaptation module LA (represented in broken lines) to determine the optimum modulation and encoding scheme for a terminal according in particular to the link indicator CQI(t) communicated by this terminal.

More generally, it should be indicated that all the functions of the user terminal UT, respectively of the base station BS, as described by way of example in conjunction with FIGS. 4a and 4b, and specially implemented for the execution, respectively the use, of the method that is the subject of the present invention, can advantageously be implemented in software form.

Thus, the invention also covers a computer program product, stored on a storage medium, to be run by a computer or by the central processing unit of a dedicated appliance, such as a user terminal UT, represented in FIG. 4a.

The abovementioned program product is noteworthy in that it comprises a series of instructions executing the steps of the method that is the subject of the invention, as described previously in conjunction with FIGS. 2a to 2c.

The invention also covers a computer program product stored on a storage medium to be run by a computer or by the central processing unit of a dedicated system, such as a base station BS of a mobile radio system, as described by way of example in conjunction with FIG. 4b.

The abovementioned computer program product is noteworthy in that it comprises a series of instructions enabling, when they are executed, the reception of quantized index values transmitted over the return channel and their storage, these quantized index values being representative of at least one reception quality value of the resources and constituting resource metrics. It also makes it possible to control the allocation of resources to each user terminal according to the abovementioned quantized index values. The abovementioned program product can be directly downloaded into the control module CMA of the base station BS.

According to an advantageous embodiment variant, the abovementioned program product also comprises instructions making it possible, when they are executed, to compare at least one quantized index value representative of the reception quality of a user with the quantized index values representative of the reception quality established for each of the other users.

The control module also includes a unit for comparing at least one quantized index value representative of the reception quality of a user with a reference value, the previously mentioned value S, this reference value itself being quantized in relation to one and the same number N of quantization levels as that used to generate the metrics of the beams in an SDMA context.

At the time of this execution, this, in an SDMA context, makes it possible to render the allocation and/or the generation of a set of beams by the base station, in particular modification of a set of beams by orienting the latter, conditional on the abovementioned reference threshold value S, as described previously in the description.

1. An information encoding method for the return channel of a mobile radio system, each base station of said system having at least one set of a plurality M of resources and transmitting periodically, to user terminals, pilot signals enabling said user terminals to measure a reception quality value associated with said resources, wherein said method includes at least the steps of:
storing of at least two reception quality values associated with said resources; and
converting each reception quality value associated with said resources, by quantization, into a quantized index value, representative of said reception quality value and constituting a metric relating to each resource.

2. The method as claimed in claim 1, wherein, for a periodic transmission of predetermined period t, said pilot signals generating a plurality of successive measurements, according to the same period, of reception quality values for each resource available on each user terminal, said method also includes:
storing, over a predetermined number T of periods prior to the current period, said reception quality values; and
creating a rolling observation window by updating of the T reception quality values, from the reception quality values of the current period.

3. The method as claimed in claim 2, wherein the set of all the reception quality values, relating to the M resources over the T updated periods, is subjected to a sorting process on each user terminal, so as to establish a succession of decreasing reception quality values, the index of each value of this succession being representative of the relative reception quality, of each of the resources with respect to the other resources and with respect to the successive trend of this reception quality in the T stored periods.

4. The method as claimed in claim 3, wherein said index of each quality value in said succession is quantized relative to a predetermined number N of quantization levels, to generate said metrics, which can be transmitted over the return channel, each comprising an integer number between 1 and N.

5. The method as claimed in claim 4, wherein said quantization levels are nonlinear.

6. The method as claimed in claim 1, wherein each resource of a set of resources is assigned an identifier, which makes it possible to implement said method on all or some of the set of resources of each base station.

7. The method as claimed in claim 1, said mobile radio system being an orthogonal frequency division multiple-carrier, multiple-access system and said resources being frequency sub-bands, wherein the method also comprises the determination of a quality indicator identifying a modulation and encoding optimum scheme for the transmission, said determination taking into account at least some of the reception quality values in said sub-bands and said corresponding quantized index values.

8. The method as claimed in claim 7, wherein the determination of the quality indicator comprises steps for:
extracting, from a set of measurements performed at a current instant, those measurements for which said quantized index values are representative of low reception quality values;
selecting, from said quantized index values, a set of measurements of lower reception quality values out of the measurements remaining after the extraction step; and
determining the quality indicator on the basis of said set of measurements.

9. A use of the method as claimed in claim 1, for allocating the resources of a set of resources of a base station of a mobile radio system, wherein said allocation is performed by comparing at least one quantized index value, representative of the reception quality of a user terminal, with the quantized index values representative of the reception quality established for each of the other user terminals.

10. The use of the method as claimed in claim 1, for the generation of a set of beams from a base station of a space-division multiple-access system, wherein said generation is conditional on a reference value, quantized relative to one and the same number N of quantization levels as that used to generate said metrics.

11. A user terminal of a mobile radio system transmitting via at least one base station periodically transmitting pilot signals enabling this user terminal to measure a reception quality value associated with the resources allocated by said base station, wherein, in addition to a central processing unit, a working memory, a module for measuring reception quality based on said pilot signals, and a transceiver module for transmitting/receiving via at least one resource of the base station, said user terminal also comprises at least:
a module for storing at least two reception quality values of said resources; and
a module for converting each reception quality value of said resources, by quantization, into a quantized index value, representative of the reception quality value and constituting a metric relating to each resource.

12. A base station of a mobile radio system, said base station comprising means of allocating resources to user terminals, and means of periodically transmitting pilot signals enabling any user terminal to measure a reception quality value of said resources, wherein the base station also comprises:
means of receiving quantized index values transmitted over the return channel by the user terminals, said quantized index values being representative of at least two reception quality values associated with said resources, and constituting metrics of said resources; and
means of controlling the allocation of said resources to each user terminal according to said quantized index values.

13. A computer program stored on a storage medium that can be read by a computer or by the central processing unit of a dedicated appliance, such as a user terminal, wherein it comprises a series of instructions for implementing the steps of the method as claimed in claim 1, when said program is run.

14. A computer program stored on a storage medium that can be read by a computer or by the central processing unit of a dedicated system such as a base station of a mobile radio system, wherein it comprises a series of instructions enabling, when they are executed, quantized index values transmitted over the return channel to be received, said quantized index values being representative of at least one reception quality value associated with said resources and constituting metrics of said resources, and the allocation of the resources to each user terminal to be controlled according to said quantized index values.
